(19) United States
(12) Patent Application Publication
(10) Pub. No.: US 2009/0072893 A1
(43) Pub. Date: Mar. 19, 2009

(54) VOLTAGE SUPPLY CIRCUIT

(75) Inventor: Akihiro Hirota, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/175,475

(22) Filed: Jul. 18, 2008

(30) Foreign Application Priority Data
Sep. 14, 2007 (JP) 2007-239470

(51) Int. Cl. G05F 1/10

(52) U.S. Cl. 327/540

(57) ABSTRACT

A voltage supply circuit which conducts a current from a power supply into a current supply line comprises a plurality of current drive circuits connected in parallel to the current supply line each of which conducts current from the power supply into the current supply line. Different reference voltages are respectively given to the plurality of current drive circuits, each of which compares a comparison voltage corresponding to a generated voltage developed across load resistors with the respective reference voltage and, when the comparison voltage exceeds the respective reference voltage, stops supplying current.

### BACKGROUND OF THE INVENTION

1. Field of the Invention

The present invention relates to a voltage supply circuit and particularly to a voltage supply circuit that supplies a voltage to nonvolatile memories such as PROMs (Programmable ROMS) including EPROM (Erasable Programmable ROM) and semiconductor memories such as RAM (Random Access Memory).

2. Description of the Related Art

In semiconductor devices, an internal power voltage supply circuit has been used to generate and supply a voltage to be used in, e.g., a semiconductor memory. Refer to, e.g., Japanese Patent Application Laid-Open Publication No. H10-027026 (hereinafter, referred to as Reference 1).

FIG. 1 shows schematically an example of a conventional voltage supply circuit to generate a voltage (hereinafter, referred to as a supply voltage) to be supplied as a drive voltage to a nonvolatile memory such as an EPROM or a semiconductor memory such as a RAM.

The voltage supply circuit 100 is configured such that current flows from an external power supply VP (voltage VP) through a transistor Q to load resistors RA, RB. A voltage divided by the load resistors RA, RB is given as a comparison voltage VW_{REF} to one terminal (e.g., a positive input terminal) of a comparator A to refer to the output voltage (generated voltage) VW of the voltage supply circuit 100. A reference voltage V_{REF} is given via a terminal TI to the other terminal (i.e., a negative input terminal) of the comparator A. Hereinafter, description will be made taking as an example the case where the transistor Q is a p-channel MOS transistor (PMOS).

The comparator A compares the comparison voltage VW_{REF} with the reference voltage V_{REF} and supplies the comparing result (a control signal) to the control electrode (gate electrode) of the drive transistor Q. When the comparison voltage VW_{REF} is lower than or equal to the reference voltage V_{REF}, the drive transistor Q conducts a current from the external power supply VP (voltage VP) to the load resistors RA, RB. Hence the output voltage (generated voltage) VW of the voltage supply circuit 100 increases.

On the other hand, when the comparison voltage VW_{REF} exceeds the reference voltage V_{REF}, the drive transistor Q becomes OFF due to the control signal indicating the comparing result of the comparator A. Hence the current from the external power supply VP (voltage VP) is cut off, so that the output voltage VW stops increasing. In this way, the output voltage VW of the voltage supply circuit 100 is controlled.

FIG. 2 shows schematically change over time in the output voltage VW and output current IW of the voltage supply circuit 100.

Generating and outputting at high speed a voltage to be used in a semiconductor memory cell is required of semiconductor devices of recent years. The use of the drive transistor Q high in current-supplying capability for generating a voltage at high speed may be thought of. However, if the drive transistor Q merely high in current-supplying capability is used, an overshoot will occur in the output voltage VW as shown in FIG. 2. Thus, access to semiconductor memory cells or the like will become impossible if margins of specified voltages such as an access voltage to semiconductor memory cells are small.

Further, as to the high speed characteristic, time TP from the end of the supply-standby state until reaching a stable voltage (a time period from time T0 to time T0′) is required to be less than or equal to 100 nsec (nanoseconds), preferably several tens nsec. However, if the drive transistor high in current-supplying capability is used, it will take much time to reach a stable voltage because the output current IW has a monotonously decreasing transition characteristic as shown in FIG. 2, and thus it is difficult to output a stable supply voltage in such a short time at high speed.

Therefore, it was difficult for the conventional voltage supply circuit to have a high speed characteristic as mentioned above and output a supply voltage within a small voltage margin of a specified voltage.

### SUMMARY OF THE INVENTION

The present invention was made in view of the above mentioned problems, and an object thereof is to provide a voltage supply circuit capable of generating and outputting a supply voltage within a small voltage margin of a specified voltage at high speed and highly accurately.

According to the present invention, there is provided a voltage supply circuit comprising a plurality of current drive circuits connected in parallel to a current supply line each of which conducts current from a power supply into the current supply line. Different reference voltages are respectively given to the plurality of current drive circuits, each of which compares a comparison voltage corresponding to a generated voltage developed across load resistors with the respective reference voltage and, when the comparison voltage exceeds the respective reference voltage, stops supplying current.

Further, each of the plurality of current drive circuits comprises a comparator that compares the comparison voltage and the respective reference voltage given to the current drive circuit to output the comparing result as a control signal; and a drive transistor that conducts current from the power supply into the current supply line according to the control signal.

Moreover, the plurality of current drive circuits sequentially stop supplying current from the power supply in the order of from the highest in current-drive capability of the drive transistor thereof according to change in the generated voltage.

In the voltage supply circuit according to the present invention, the plurality of current drive circuits to supply current to load resistors are connected in parallel. The plurality of current drive circuits are sequentially switched to stop supplying current into the current supply line according to change in the generated voltage.

Thus, even if the voltage margin is small, a supply voltage within the voltage margin of a specified voltage can be generated highly accurately without an overshoot or the like occurring in the generated voltage. Further, the supply voltage within the voltage margin of the specified voltage can be supplied In a very short time from the end of the standby state, thus enabling high speed operation. A voltage VW_{S} within the margin of the specified voltage can be generated and supplied in, e.g., less than 40 nsec, particularly 20 nsec, from the end of the standby state.

### BRIEF DESCRIPTION OF THE DRAWINGS

FIG. 1 shows schematically an example of a conventional voltage supply circuit;

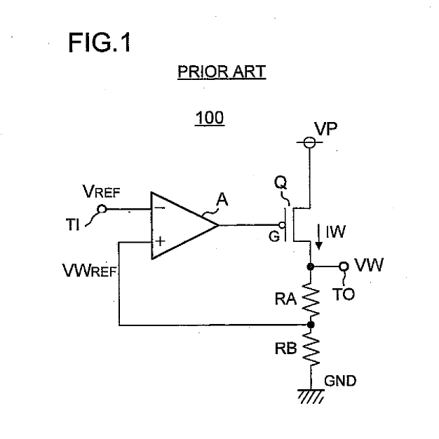

FIG. 2 shows schematically change over time in the output voltage VW and output current IW of the voltage supply circuit of FIG. 1;

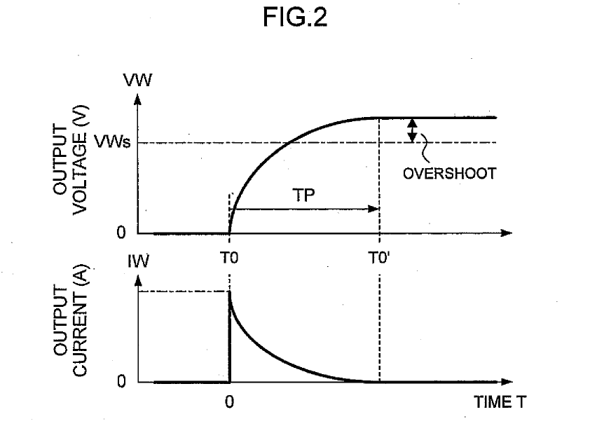

FIG. 3 shows schematically an example of a voltage supply circuit which is a first embodiment of the present invention;

FIG. 4 shows schematically change over time in the output voltage VW and output current IW of the voltage supply circuit of the first embodiment;

FIG. 5 shows schematically an example of a voltage supply circuit which is a second embodiment of the present invention;

FIG. 6 shows schematically change over time in the output voltage VW and output current IW of the voltage supply circuit of the second embodiment; and

FIG. 7 shows schematically an example of a voltage supply circuit which is a third embodiment of the present invention.

### DETAILED DESCRIPTION OF THE INVENTION

Embodiments of the present invention will be described in detail below with reference to the drawings. In the figures herein, substantially the same or equivalent components or parts are denoted by the same reference numerals.

### First Embodiment

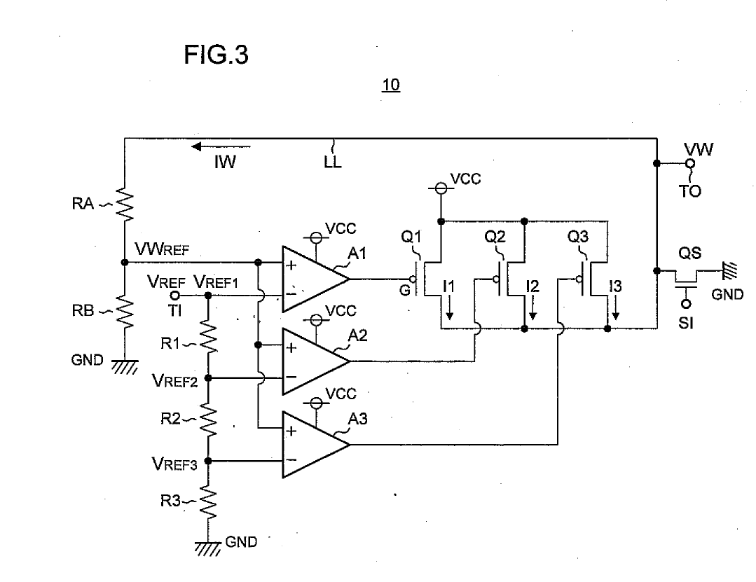

FIG. 3 shows schematically an example of a voltage supply circuit 10 which is a first embodiment of the present invention. The voltage supply circuit 10 generates a voltage to be supplied to a nonvolatile memory such as an EPROM or a semiconductor memory such as a RAM. To be more specific, the voltage supply circuit 10 generates a voltage to be used in a semiconductor memory to produce various drive voltages for semiconductor memory cells such as a word line voltage and supplies to the semiconductor memory. In particular, the voltage supply circuit 10 is configured to be able to generate a supply voltage within a small voltage margin of a specified voltage highly accurately and supply the supply voltage within the margin of the specified voltage in a very short time from the end of the supply-standby state, that is, operate at high speed. In the present embodiment, description will be made taking as an example the case where the voltage supply circuit 10 supplies the voltage to an EPROM.

### [Configuration of the Voltage Supply Circuit 10]

Referring to FIG. 3, when a current IW flows through load resistors RA, RB of the voltage supply circuit 10, the output voltage VW of the voltage supply circuit 10 is generated. That is, the voltage supply circuit 10 generates the voltage VW and outputs through the output terminal TO of the voltage supply circuit 10. A voltage obtained by dividing the generated voltage VW with the load resistors RA, RB is given as a voltage VW_{REF} (hereinafter, referred to as a comparison voltage) to one terminal (positive input terminal) of each of first to third comparators A1, A2, A3 to refer to the output voltage (generated voltage) VW of the voltage supply circuit 10.

Reference voltages V_{REF1}, V_{REF2}, V_{REF3} are respectively given to the other terminals (i.e., negative input terminals) of the corresponding first to third comparators A1, A2, A3. In the present embodiment, a reference voltage V_{REF} is given to the voltage supply circuit 10 via a terminal TI from outside the circuit 10. Voltages obtained by dividing the reference voltage V_{REF} with reference voltage divider resistors R1, R2, R3 are given as the reference voltages V_{REF1}, V_{REF2}, V_{REF3}. That is, between the reference voltages, there is the relationship in magnitude that V_{REF1}>V_{REF2}>V_{REF3}. The reference voltages V_{REF1} supplied to the first comparator A1 is the input reference voltage V_{REF} (i.e., V_{REF1}=V_{REF}). A voltage VCC from an external power source is supplied as a power supply voltage to the first to third comparators A1, A2, A3. The external power supply voltage VCC is, for example, 2.7 to 3.6 V.

The reference voltages V_{REF1}, V_{REF2}, V_{REF3} are not limited to voltages obtained by dividing the external reference voltage V_{REF} with resistors but may be supplied externally and individually. Or, needless to say, a reference voltage generating circuit for generating the reference voltages V_{REF1}, V_{REF2}, V_{REF3} may be provided in the voltage supply circuit 10.

The outputs of the first to third comparators A1, A2, A3 are respectively supplied to the control electrodes (gate electrodes) of first to third drive transistors Q1, Q2, Q3. In the below, description will be made taking as an example the case where the first to third drive transistors Q1, Q2, Q3 are each a p-channel MOS transistor (PMOS).

The first to third drive transistors Q1, Q2, Q3 are different in current-supplying capability from each other. Let J1, J2, J3 be the current-supplying capabilities of the first to third drive transistors Q1, Q2, Q3, then J1<J2<J3. For example, by changing element parameters such as channel width and/or channel length, the current-supplying capabilities of the first to third drive transistors Q1, Q2, Q3 can be changed.

In the present embodiment, the channel width and channel length of the first to third drive transistors Q1, Q2, and Q3 are, for example, (100 μm, 0.25 μm), (400 μm, 0.25 μm), and (800 μm, 0.25 μm), respectively. But, not being limited to this, they may be set according to the necessary current-supplying capability as needed.

To be more specific, the first comparator A1 compares the comparison voltage VW_{REF} with the reference voltage V_{REF1} and supplies the comparing result (a control signal) to the control electrode (gate electrode) of the first drive transistor Q1. If the comparison voltage VW_{REF} is lower than or equal to the reference voltage V_{REF1}, the first comparator A1 outputs the signal of a low level. Thus, the first drive transistor Q1 is turned on and conducts a current I1 from the external power supply VCC (voltage VCC) to the load resistors RA, RB through a load line (current supply line) LL.

Likewise, the second and third comparators A2, A3 compare the comparison voltage VW_{REF} with the reference voltages V_{REF2}, V_{REF3} respectively and supply the comparing results (control signals) to the control electrodes (gate electrodes) of the second and third drive transistors Q2, Q3. If the comparison voltage VW_{REF} is lower than or equal to the reference voltage V_{REF2}, the second comparator A2 outputs the signal of the low level, and thus the second drive transistor Q2 conducts a current I2 from the external power supply VCC (voltage VCC) into the load line LL. If the comparison voltage VW_{REF} is lower than or equal to the reference voltage V_{REF3}, the third comparator A3 outputs the signal of the low level, and thus the third drive transistor Q3 conducts a current I3 from the external power supply VCC (voltage VCC) into the load line LL.

Thus, when all the drive transistors Q1, Q2, Q3 are in an ON state, a current IW (=I1+I2+I3) flows through the load line LL.

In other words, the first comparator A1 and the first drive transistor Q1 constitute a first current drive circuit (current drive system); the second comparator A2 and the second drive transistor Q2 constitute a second current drive circuit (current drive system); and the third comparator A3 and the third drive transistor Q3 constitute a third current drive circuit (current drive system). That is, the first to third current drive circuits are connected in parallel to the load line LL, and the sum (I1+I2+I3) of the currents supplied by the first to third current drive circuits determines the current IW flowing into the load line LL.

Further, the load line LL is provided with a pull-down transistor QS as a switch to switch from the supply-standby state to starting to supply a current into the load line LL. To be more specific, the pull-down transistor QS is constituted by, e.g., an NMOS (n-channel MOS transistor) and is used as a switch to connect the potential on the load line LL to ground potential (GND) when ON. That is, the pull-down transistor QS switches (ON/OFF) between connecting and cutting the potential on the load line LL to and off from ground potential (GND) according to a gate control signal SI.

### [Operation of Generating the Supply Voltage]

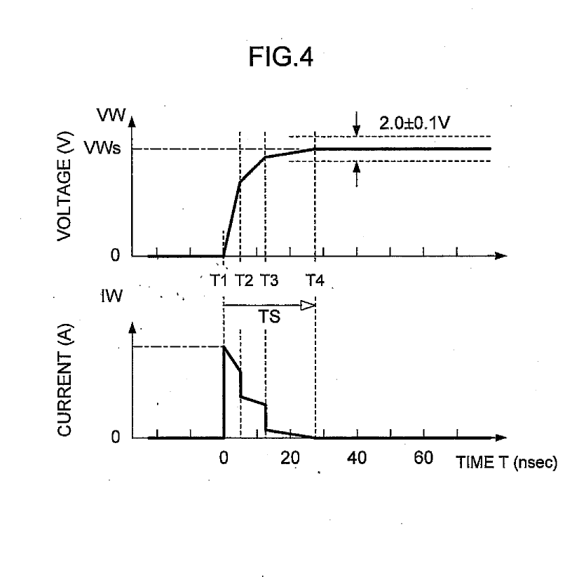

The operation of generating the supply voltage (output voltage) VW of the voltage supply circuit 10 based on the current IW supplied by the first to third current drive circuits will be described in detail below with reference to the drawings. FIG. 4 shows schematically change over time in the output voltage VW and output current IW of the voltage supply circuit 10.

In the voltage supply circuit 10, in the standby state (until time T1 in FIG. 4), the pull-down transistor QS is ON and connects the load line LL to ground potential (GND).

At the end of the standby state, at which time the supply voltage starts to be generated (at time T=T1=0), the pull-down transistor QS is turned off by the gate control signal SI to cut the load line LL off from ground potential (GND). In the present embodiment, at the start of generating the supply voltage, the output voltage VW is at 0 V (GND), and the output voltage VW increases from the 0 V (standby voltage) to a supply voltage within the margin of the specified voltage.

When the load line LL has been cut off from ground potential (GND), the first to third comparators A1, A2, A3 compare the comparison voltage VW_{REF} with the reference voltages V_{REF1}, V_{REF2}, V_{REF3} respectively and output the comparing results (control signals) to the first to third drive transistors Q1, Q2, Q3. At this point in time, because the comparison voltage VW_{REF} is smaller than any of the reference voltages V_{REF1}, V_{REF2}, V_{REF3} of the first to third comparators A1, A2, A3, all the first to third comparators A1, A2, A3 output the control signal of a low level to the first to third drive transistors Q1, Q2, Q3. Thus, all the first to third drive transistors Q1, Q2, Q3 become ON and conduct a current from the external power supply VCC into the load line LL. That is, the first to third drive transistors Q1, Q2, Q3 conduct the currents I1, I2, I3 respectively, and the current IW (=I1+I2+I3) is supplied into the load line LL. Thus, the output voltage VW increases as shown in FIG. 4 (the period from T1 to T2).

As the output voltage VW increases, the comparison voltage VW_{REF} also increases. At the time point (time T2) when the comparison voltage VW_{REF} becomes higher than the reference voltage V_{REF3}, the output of the third comparator A3 switches from the low level to a high level. That is, the third comparator A3 supplies the control signal of the high level to the third drive transistor Q3, and thus the third drive transistor Q3 becomes in an OFF state (turned off). The third drive transistor Q3 having the highest current-supplying capability among the first to third drive transistors Q1, Q2, Q3 is made to stop supplying a current. In other words, the third current drive circuit highest in the current-supplying capability stops supplying a current into the load line LL.

Thereafter, although the third drive transistor Q3 stops supplying a current, the output voltage VW increases due to the current supplied by the first and second drive transistors Q1, Q2. That is, the current IW supplied into the load line LL is equal in amount to I1+I2 and is smaller than when all the first to third drive transistors Q1, Q2, Q3 were supplying a current (the period from T1 to T2), and hence the increase gradient of the output voltage VW is reduced as shown in FIG. 4 (the period from T2 to T3).

As the output voltage VW further increases, the comparison voltage VW_{REF} increases. At the time point (time T3) when the comparison voltage VW_{REF} becomes higher than the reference voltage V_{REF2}, the output of the second comparator A2 switches from the low level to the high level. That is, the second comparator A2 supplies the control signal of the high level to the second drive transistor Q2, and thus the second drive transistor Q2 becomes OFF. The second drive transistor Q2 second highest to the third drive transistor Q3 in the current-supplying capability among the first to third drive transistors Q1, Q2, Q3 is made to stop supplying a current. In other words, the second current drive circuit stops supplying a current into the load line LL as well as the current supply of the third current drive circuit being stopped. Thus, after time T3, only the first current drive circuit supplies a current into the load line LL.

Although the second and third drive transistors Q2, Q3 have stopped supplying a current, the output voltage VW increases due to the current supplied by the first drive transistor Q1. That is, the current IW supplied is equal in amount to I1 and is smaller than when the first and second drive transistors Q1, Q2 were supplying a current (the period from T2 to T3), and hence the increase gradient of the output voltage VW is further reduced as shown in FIG. 4 (the period from T3 to T4).

As the output voltage VW further increases, the comparison voltage VW_{REF} increases. At the time point (time T4) when the comparison voltage VW_{REF} reaches the reference voltage V_{REF1}, the output of the first comparator A1 switches from the low level to the high level. Thereby the first drive transistor Q1 becomes OFF. Thus, the first drive transistor Q0 also stops supplying a current, so that all the current supply of the first to third current drive circuits is stopped. The output voltage VW of the voltage supply circuit 10 reaches a voltage VW_{S} within the margin of the specified voltage. The voltage VW_{S} is supplied as the supply voltage to a semiconductor memory through the output terminal TO.

As described above, the current drive circuits sequentially stop supplying a current into the load line LL in the order of from the highest in the current-supplying capability.

That is, a plurality of the current drive circuits (in the present embodiment, the first to third current drive circuits) to supply a current to the load resistors are connected in parallel to the load line LL, and the plurality of current drive circuits are sequentially switched to stopping supplying a current into the current supply line according to the change in the voltage (comparison voltage) obtained by dividing the generated voltage with the resistors.

According to the present embodiment, time from the end of the standby state (standby voltage of 0 V) until the output voltage reaches the stable supply voltage VW_{S} (the period from T1 to T4, i.e., the time required to generate the supply voltage) can be made very short. The voltage VW_{S} within the margin of the specified voltage can be generated and supplied in no greater than 40 nsec from the end of the standby state.

In particular, for a specified supply voltage of, e.g., 2.0±0.1 V (1.9 to 2.1 V), the output voltage VW can be made to increase from the standby state voltage (=0 V in the present embodiment) to the supply voltage VW_{S} within the margin of the specified voltage as shown in FIG. 4, and the time required to generate the supply voltage VW_{S} (the period TS from T1 to T4) can be made less than 30 nsec.

### Second Embodiment

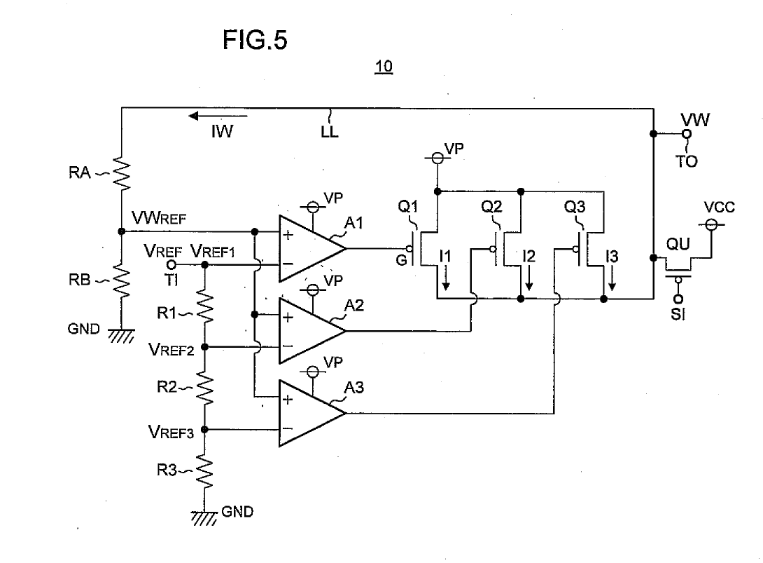

FIG. 5 shows schematically an example of a voltage supply circuit 10 which is a second embodiment of the present invention. The present embodiment is the same in configuration as the first embodiment but different in the following points from the first embodiment.

That is, instead of the pull-down transistor QS of the first embodiment, a pull-up transistor QU is connected to the load line LL. To be more specific, the pull-up transistor QU is constituted by, e.g., a PMOS and is used as a switch to connect the potential on the load line LL to an external power supply voltage VCC (e.g., 2.7 to 3.6 V) when ON. That is, the pull-up transistor QU switches (ON/OFF) between connecting and cutting the potential on the load line LL to and off from the external power supply voltage VCC according to a gate control signal SI.

Further, the first to third comparators A1, A2, A3 and the first to third drive transistors Q1, Q2, Q3 of the first to third current drive circuits are connected to a voltage VP (of, e.g., 4 V) (hereinafter, referred to as a second power supply voltage) generated by boosting the external power supply voltage VCC (of, e.g., 2.7 to 3.6 V) (hereinafter, referred to as a first power supply voltage).

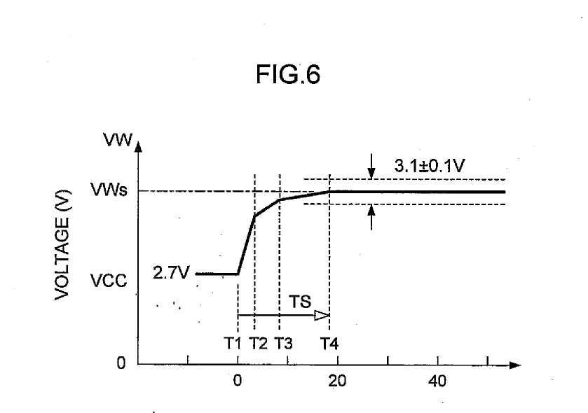

The operation of the voltage supply circuit 10 of the present embodiment will be described below. FIG. 6 shows schematically change over time in the output voltage VW and output current IW of the voltage supply circuit 10.

In the voltage supply circuit 10 of the present embodiment, in the standby state (until time T1 in FIG. 6), the pull-up transistor QU is ON and connects the load line LL to the external power supply voltage VCC.

At the end of the standby state, at which time the supply voltage starts to be generated (at time T=T1=0), the pull-up transistor QU is turned off by the gate control signal SI to cut the load line LL off from the external power supply voltage (first power supply voltage) VCC. In the present embodiment, at the start of generating the supply voltage, the output voltage VW is at VCC, and the output voltage VW increases from the VCC to a supply voltage within the margin of a specified voltage. In the below, description will be made taking as an example the case where the first power supply voltage VCC=2.7 V and the specified value of the supply voltage of the voltage supply circuit 10 is at 3.1±0.1 V (3.0 to 3.2 V).

When the load line LL has been cut off from the first power supply voltage VCC, the first to third comparators A1, A2, A3 compare the comparison voltage VW_{REF} with the reference voltages V_{REF1}, V_{REF2}, V_{REF3} respectively and output the comparing results (control signals) to the first to third drive transistors Q1, Q2, Q3. In the present embodiment, the voltage VCC is set such that the comparison voltage VW_{REF} at this point is smaller than any of the reference voltages V_{REF1}, V_{REF2}, V_{REF3} of the first to third comparators A1, A2, A3, and hence all the first to third comparators A1, A2, A3 output the control signal of a low level to the first to third drive transistors Q1, Q2, Q3. Thus, all the first to third drive transistors Q1, Q2, Q3 become ON and conduct a current from the second power supply VP into the load line LL. That is, the first to third drive transistors Q1, Q2, Q3 conduct the currents I1, I2, I3 respectively, and the current IW (=I1+I2+I1) is supplied into the load line LL. Thus, the output voltage VW increases as shown in FIG. 6 (the period from T1 to T2).

As the output voltage VW increases, the comparison voltage VW_{REF} also increases. At the time point (time T2) when the comparison voltage VW_{REF} becomes higher than the reference voltage V_{REF3}, the output of the third comparator A3 switches from the low level to a high level. Thus the third drive transistor Q3 becomes OFF. That is, the third drive transistor Q3 highest in the current-supplying capability is made to stop supplying a current.

Although the third drive transistor Q3 stops supplying a current, the output voltage VW increases due to the current supplied by the first and second drive transistors Q1, Q2. That is, the current IW supplied is equal in amount to I1+I2, and hence the increase gradient of the output voltage VW is reduced as shown in FIG. 6 (the period from T2 to T3).

As the output voltage VW further increases, the comparison voltage VW_{REF} increases. At the time point (time T3) when the comparison voltage VW_{REF} becomes higher than the reference voltage V_{REF2}, the output of the second comparator A2 switches from the low level to the high level. Thus the second drive transistor Q2 becomes OFF. The second drive transistor Q2 second highest to the third drive transistor Q3 in the current-supplying capability is made to stop supplying a current. Thus, after time T3, only the first current drive circuit supplies a current into the load line LL.

After the second and third drive transistors Q2, Q3 have stopped supplying a current, the output voltage VW increases due to the current supplied by the first drive transistor Q1. That is, the current IW supplied is equal in amount to I1, and hence the increase gradient of the output voltage VW is further reduced as shown in FIG. 6 (the period from T3 to T4).

As the output voltage VW further increases, the comparison voltage VW_{REF} increases. At the time point (time T4) when the comparison voltage VW_{REF} reaches the reference voltage V_{REF1}, the output of the first comparator A1 switches from the low level to the high level. Thereby the first drive transistor Q1 becomes OFF. Thus, the first drive transistor Q1 also stops supplying a current, so that all the current supply of the first to third current drive circuits is stopped. The output voltage VW of the voltage supply circuit 10 reaches a voltage VW_{S} within the margin of the specified voltage. The voltage VW_{S} is supplied as the supply voltage to a semiconductor memory through the output terminal TO.

According to the present embodiment, time from the end of the standby state (the first power supply voltage VCC >0) until the output voltage reaches the stable supply voltage VW_{S} (the period TS from T1 to T4, i.e., the time required to generate the supply voltage) can be made very short. The voltage VW_{S} within the margin of the specified voltage can be generated and supplied in no greater than 40 nsec from the end of the standby state.

In particular, the output voltage VW can be made to increase from the standby state voltage (˜2.7 V in the present embodiment) to the supply voltage VW_{S} within the margin of the specified voltage (3.1±0.1 V) as shown in FIG. 6, and the time required to generate the supply voltage VW_{S} (the period from T1 to T4) can be made less than 20 nsec.

The time required to generate the specified supply voltage (the period from T1 to T4) depends on the configuration of the first to third current drive circuits, the reference voltages V_{REF1}, V_{REF2}. V_{REF3}, the voltage during the standby state (at the start of generating the output voltage) (2.7 V in the present embodiment), and the like. Thus, by changing these parameters in value, the time required to generate the specified supply voltage (supply voltage generating time) and the voltage accuracy of the supply voltage VW_{S} can be set as needed. According to the present embodiment, by using the second power supply voltage as well as the first power supply voltage and setting the values of these voltages as needed, the time required to generate the specified supply voltage can be reduced, and in addition the voltage accuracy of the supply voltage VW_{S} can be increased.

### Third Embodiment

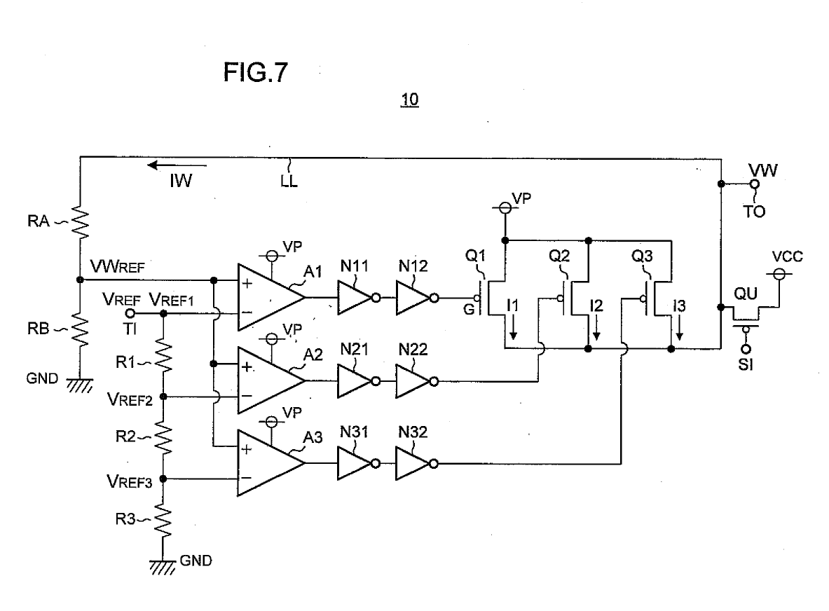

FIG. 7 shows schematically an example of a voltage supply circuit 10 which is a third embodiment of the present invention. The present embodiment is the same in configuration as the second embodiment but different in the following points from the second embodiment.

That is, in the first current drive circuit, two stages of inverters N11, N12 are provided in between the output terminal of the first comparator A1 and the gate electrode of the first drive transistor Q1. Likewise in the second and third current drive circuits, two stages of inverters N21, N22 are provided in between the output terminal of the second comparator A2 and the gate electrode of the second drive transistor Q2, and two stages of inverters N31, N32 are provided in between the output terminal of the third comparator A3 and the gate electrode of the third drive transistor Q3.

The first current drive circuit will be described. At the time point (time T2) when the comparison voltage VW_{REF} becomes higher than the reference voltage V_{REF3}, the output of the third comparator A3 switches from the low level to the high level, but the level change takes a transition time, though short. Thus, without the two stages of inverters, the third drive transistor Q3 does not instantaneously become completely OFF, but the third drive transistor Q3 conducts a current into the load line LL during the short transition time even after time T2.

In the present embodiment, because the two stages of inverters are provided at the back of each comparator, the output signal of the comparator is reshaped into a square wave. Thus, a control signal changing sharply is supplied to the gate electrode of the drive transistor at the back of the comparator, and hence the problem of the current supply in the transition time does not occur.

Although the case where the reshaping circuit for the output signal of each comparator is constituted by two stages of inverters has been described, not being limited to this, of course various digital gate circuits and the like can be used.

### Fourth Embodiment

The above embodiments can be modified and applied in combination. Modified examples of the present invention will be described below.

(1) Although in the above embodiments three current drive circuits (current drive systems) are connected in parallel to the load line LL, the number of current drive circuits can be set as needed.

That is, a plurality of current drive circuits (first to n-th current drive circuits) may be provided, and the plurality of current drive circuits may be configured to sequentially stop supplying a current into the load line LL as the output voltage VW of the voltage supply circuit 10 increases (or decrease).

To be more specific, the number of current drive circuits can be set according to the voltage during the standby state (at the start of generating the output voltage), time from the end of the standby state to the start of supplying a specified supply voltage, the margin of the specified supply voltage, the current-supplying capabilities of drive transistors, and the like.

Although in the above embodiments the case where the output voltage increases from the standby voltage has been described, the same applies to the case where the output voltage decreases from the standby voltage. For this case, the above embodiments can be changed as needed in terms of the standby voltage, the supply voltage, the polarity (p/n) of drive transistors, the reference voltages of the comparators, the polarities (positive/negative) of the input terminals of the comparators to which the reference voltages and comparison voltage are input, and the like.

(2) The time from the end of the standby state until the output voltage reaches a stable voltage (the time TS required to generate the specified supply voltage) depends on the configuration of the plurality of current drive circuits (the first to the n-th current drive circuits), that is, the current-supplying capabilities of the first to n-th drive transistors Q1 to Qn, the current-supplying capabilities of the first to n-th comparators A1 to An, the reference voltages V_{REF1} to V_{REFn} given to the first to n-th comparators A1 to An, the voltage during the standby state (at the start of generating the output voltage), and the like. Thus, by changing these parameters, the time required to generate the specified supply voltage (supply voltage generating time) and the accuracy of the supply voltage can be set as needed.

(3) In the above embodiment, there has been described the case where the first to third drive transistors Q1, Q2, Q3 are different in current-supplying capability from each other with their J1, J2, J3 having the relationship that J1<J2<J3, but the invention is not limited to this.

A plurality of current drive circuits (first to nth current drive circuits) may be provided, and at least two of the current drive circuits may be configured to have the same current-supplying capability. Also in this case, by making the plurality of current drive circuits sequentially stop supplying a current, the amount of current supplied into the load line LL can be decreased stepwise, and hence the supply voltage can be generated and outputted at high speed and highly accurately. Also in this case, the current drive circuits are preferably made to sequentially stop supplying a current into the load line LL in the order of from the highest in current-supplying capability.

As described above, according to the present invention a supply voltage within a small voltage margin of a specified voltage can be generated and outputted at high speed and highly accurately.

The present invention has been described with reference to a preferred embodiment. It should be understood that those skilled in the art can think of various modifications and changes and that all variants made by those modifications and changes fall within the scope of the present invention as defined by the appended claims.

The present application claims priority from Japanese Patent Application No. 2007-239470, which is herein incorporated by reference.

What is claimed is:

1. A voltage supply circuit which conducts a current from a power supply through a current supply line to load resistors to output a generated voltage developed across said load resistors, comprising:
a plurality of current drive circuits connected in parallel to said current supply line each of which conducts current from said power supply into said current supply line,
wherein different reference voltages are respectively given to said plurality of current drive circuits, each of which compares a comparison voltage corresponding to said generated voltage with the respective reference voltage and, when said comparison voltage exceeds the respective reference voltage, stops supplying current from said power supply.

2. A voltage supply circuit according to claim 1, wherein each of said plurality of current drive circuits comprises:
a comparator that compares said comparison voltage and the respective reference voltage to output the comparing result as a control signal; and
a drive transistor that conducts current from said power supply into said current supply line according to said control signal.

3. A voltage supply circuit according to claim 2, wherein the reference voltages that are given to respective comparators of said plurality of current drive circuits are set such that said current drive circuits sequentially stop supplying current from said power supply in the order of from the highest in current-drive capability of said drive transistor thereof according to change in said generated voltage.

4. A voltage supply circuit according to claim 3, wherein said drive transistors of said plurality of current drive circuits have different current-drive capabilities from each other.

5. A voltage supply circuit according to claim 3, wherein the reference voltages that are given to the respective comparators of said plurality of current drive circuits are generated by dividing an input voltage with resistors.

6. A voltage supply circuit according to claim 1, further comprising:
a switching circuit to connect said current supply line to a predetermined standby voltage,
wherein said plurality of current drive circuits cut off current supply from said power supply during the time that said switching circuit connects said current supply line to said standby voltage, and conduct current from said power supply during the time that said switching means cuts said current supply line off from said standby voltage.

7. A voltage supply circuit according to claim 6, wherein said standby voltage is ground potential.

8. A voltage supply circuit according to claim 3, wherein each of said plurality of current drive circuits comprises a digital gate circuit provided in between said comparator and a control electrode of said drive transistor to reshape an output signal of said comparator into a square wave.

9. A voltage supply circuit according to claim 1, further comprising a current drive circuit switch which performs switching of said current drive circuits such that said current drive circuits sequentially stop supplying current from said power supply in the order of from the highest in current-drive capability.

10. A voltage supply circuit according to claim 1, wherein at least two of said plurality of current drive circuits are configured to have the same current-supplying capability.

11. A voltage supply circuit according to claim 6, wherein said standby voltage is between ground potential and a specified supply voltage.

12. A voltage supply circuit according to claim 8, wherein said digital gate circuit comprises two-stage inverter circuit.
